(19) United States
(12) Patent Application Publication
(10) Pub. No.: US 2006/0074782 A1
(43) Pub. Date: Apr. 6, 2006

(54) Method for transacting securities

(76) Inventor: Carl Johansson, Skarhamn (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/852,392

(22) Filed: May 24, 2004

Related U.S. Application Data
(60) Provisional application No. 60/473,108, filed on May 24, 2003.

(51) Int. Cl. G06Q 40/00

(52) U.S. Cl. 705/35

(57) ABSTRACT

The method is for purchasing and selling securities. A first bottom value of a security price of a security is identified. A first purchase signal is triggered when the identified security price exceeds a difference (E) above the bottom value. A first peak value of the security price is then identified. A first sell signal is triggered when the security price exceeds the difference (E) below the first peak value.

### TECHNICAL FIELD

The invention relates to a method for transacting securities such as buying and selling equity stock.

### BACKGROUND OF INVENTION

The stock market is currently very volatile with big shifts in the stock prices. It makes it very difficult for purchaser and sellers of stocks to know when to buy and sell a stock. For example, there is a risk for heavy losses when the buyer keeps a stock too long in a declining market or a seller may sell the stock before it has climbed sufficiently in a rising market. There is a need for a reliable and effective method or program to indicate when to buy and selling equity stocks that will reduce the risk of heavy losses while enabling the possibility of earning money even during declining stock prices.

### SUMMARY OF INVENTION

The method of the present invention provides a solution to the above-outlined problems. More particularly, the method is for purchasing and selling securities such as stocks. A first bottom value of a security price of a security is identified. A first purchase signal is triggered when the identified security price exceeds a difference (E) above the bottom value. A first peak value of the security price is then identified. A first sell signal is triggered when the security price exceeds the difference (E) below the first peak value.

### BRIEF DESCRIPTION OF THE DRAWINGS

FIG. 1 is a schematic illustration of the method of the present invention.

### DETAILED DESCRIPTION

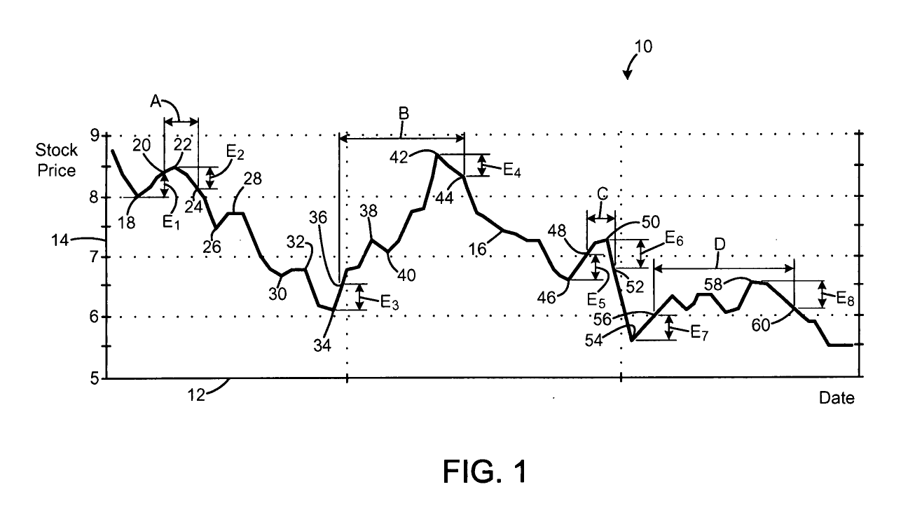

The method of the present system may be used for transacting securities such as buying and selling stocks and other equities. With reference to FIG. 1, the fluctuations of the stock prices of a stock during a day are shown. The present method applies to any length of time. More particularly, FIG. 1 has a left X-axis 12 showing the stock price, a right X-axis showing the number of stocks transacted and a Y-axis 14 showing the date or hour of the varying stock prices. A value line 16 indicates the variations of the stock price. An important feature of the method of the present invention is that the method or computer program identifies and records all stock prices including peak values and bottom values of the value line 16.

For example, the method 10 records and identifies a bottom value 18. The method may be set to trigger a purchasing signal when the stock price exceeds the bottom value 18 with a preset amount such as a difference (E1) to a purchase trigger value 20. The difference (E1) may be any absolute value such as 40 cents or any absolute percentage such as 5% or any such percentage, as desired. The difference may also be a value that is proportionate to the stock price so that the difference is increased/reduced as the stock price increases/declines.

The method then identifies and records the next turning point that is the peak value 22. Of course, the program identifies all the stock prices between the bottom value 18 and the peak value 22 also. For purposes of clarity, only the bottom values and the peak values are described. When the value of the stock has been reduced with the difference (E2) from the peak value 22, the method generates or triggers a sell signal at the sell trigger value 24. Preferably, the difference (E2) is identical to the difference (E1). Of course, it may be possible to set the values so that the difference (E2) is different from the difference (E1). In this way, the stock is held during a time period (A) and purchased at the value 20 and sold at the value 24.

The method then identifies and records the bottom value 26. However, no purchase signal is triggered because the stock value did not exceed the difference (E) at the next peak 28. This also applies to the bottom value 30 followed by the peak value 32. Although the stock price was reduced with more than the difference (E) from the peak value 28 to the bottom value 30 no sell signal was triggered because the method is looking for a purchase opportunity since the stock was sold at the sell trigger value 24.

The method then identifies records the bottom value 34 and a purchase signal is triggered at the purchase trigger value 36 because the stock price has increased more than the difference (E3) that, preferably, is the same as the differences (E1, E2) above. The peak value 38 is then identified but no sell signal is triggered at or before a bottom value 40 because the difference between the peak value 38 and the bottom value 40 is less than the difference (E).

A peak value 42 is then identified and recorded and a sell signal is triggered at a sell trigger value 44 because the difference between the peak value 42 and the value 44 is a difference (E4). The difference (E4) is preferably the same value as the differences (E1, E2, E3) mentioned above. The stock is held during a time period (B) from the time the stock was purchased at the value 36 until the stock was sold at the value 44.

A bottom value 46 is then identified that generates a purchase signal at a purchase trigger value 48 because the difference (E5) is obtained. A peak value 50 is identified and a sell signal is generated at a sell trigger value 52 so that the stock is held during a time period (C) extending from the time of the purchase of the stock at the value 48 to the time for selling the stock at the value 52.

Similar to the above-described methodology, a bottom value 54 is identified and a purchase signal is triggered at a purchase trigger value 56 because a difference (E7) has been reached from the bottom value 54. A peak value 58 triggers a sell signal at a sell trigger value 60. In this way, the stock is held during a time period (D) that extends from the time of the purchase at the value 56 to the time of the sale at the value 60.

It should be understood that the differences (E) are preferably an absolute value that is the same. However, if desired the user may change the difference value that triggers a purchase or sell as desired. A indicated above, the difference (E) may also be proportional to the current stock price so that the difference (E) dynamically changes with the stock price. It should also be noted that the time period between purchase and sale is not limited by time since it is governed by the difference (E) relative to a bottom value or a peak value. This means that the time periods (A, B, C, D) may vary greatly.

In the illustrative example, the user of the method of the present invention has earned money on the stock although the total stock value was reduced from about $8.75 to about $5.50. More particularly, the purchaser lost −$0.35 ($8.05−$8.40) during the time period A, gained +$1.80 ($6.50−$8.30) during the time period B, lost −$0.10 ($7.00−$6.90) during the time period C and gained +$0.20 ($6.00−$6.20) during the time period D. The total gain is therefore +$1.55 although the stock lost −$3.25 in value. Due to the automatic trigger signals, big risks and heavy losses are reduced by the method of the present invention. The method even makes it possible to earn money in a declining market. The transaction costs are not included in the above example. The method may also include the feature of automatically purchasing and selling stock so that there is no need for any manual action on the part of the user of the program.

While the present invention has been described in accordance with preferred compositions and embodiments, it is to be understood that certain substitutions and alterations may be made thereto without departing from the spirit and scope of the following claims.

1. A method of purchasing and selling securities, comprising:
identifying a first bottom value of a security price of a security;
triggering a first purchase signal when the security price exceeds a difference (E) above the bottom value;
identifying a first peak value of the security price; and
triggering a first sell signal when the security price exceeds the difference (E) below the first peak value.

2. The method according to claim 1 wherein the method further comprises setting the difference (E) to an absolute value.

3. The method according to claim 1 wherein the method further comprises identifying a second bottom value of the security price and triggering a second purchase signal when the security price exceeds the difference (E) above the second bottom value.

4. The method according to claim 3 wherein the method further comprises identifying a second peak value and triggering a second sell signal when the security price exceeds the difference (E) below the second peak value.

5. The method according to claim 1 wherein the method further comprises continuously identifying bottom values and peak values of the security price.

6. The method according to claim 1 wherein the method automatically triggers the first purchase signal and the first sell signal.

7. The method according to claim 1 wherein the difference (E) is proportionate to the security price so that the difference (E) increases when the stock price increases and declines when the stock price declines.
